(19) United States
(12) Patent Application Publication
(10) Pub. No.: US 2026/0209970 A1
(43) Pub. Date: Jul. 23, 2026

(54) RUTHENIUM OXIDE DECORATED WITH PLATINUM OXIDE AND ELECTRODES FOR THE OXYGEN EVOLUTION REACTION

(71) Applicant: BASF SE, Ludwigshafen am Rhein (DE)

(72) Inventors: Stefan KOTREL, Ludwigshafen am Rhein (DE); Daniel MALKO, Nienburg/Weser (DE); Britta MAYERHOEFER, Ladenburg (DE)

(21) Appl. No.: 19/139,114

(22) PCT Filed: Dec. 18, 2023
(86) PCT No.: PCT/EP2023/086467

§ 371 Date: Jun. 13, 2025

(30) Foreign Application Priority Data
Dec. 16, 2022 (EP) 22214222.6

(51) Int. Cl. C25B 11/093; H01M 4/90

(52) U.S. Cl. CPC C25B 11/093; H01M 4/9016

(57) ABSTRACT

A ruthenium oxide decorated with transition metal (M) oxide, wherein M=Pt, Rh, Pd, Ag and/or Au, particularly ruthenium oxide decorated with platinum oxide catalysts for polymer electrolyte membrane (PEM) fuel cells, water electrolysis, regenerative fuel cells (RFC) or oxygen generating electrodes in various electrolysis applications.

The present invention relates to a ruthenium oxide decorated with transition metal (M) oxide, wherein M=Pt, Rh, Pd, Ag and/or Au, particularly ruthenium oxide decorated with platinum oxide catalysts for polymer electrolyte membrane (PEM) fuel cells, water electrolysis, regenerative fuel cells (RFC) or oxygen generating electrodes in various electrolysis applications. The present invention further relates to a process for obtaining a catalyst composition, to a catalyst composition obtainable or obtained by said process, to an electronic device, comprising said catalyst composition, and to the catalyst composition used as a catalyst for an oxygen evolution reaction.

Hydrogen is a promising clean energy carrier that can be produced by various technologies. High-quality hydrogen can be produced by water electrolysis. As known to the skilled person, a water electrolyzer contains at least one anode-containing half cell where the oxygen evolution reaction (OER) takes place, and at least one cathode-containing half cell where the hydrogen evolution reaction (HER) takes place. If two or more cells are linked together, a stacked configuration is obtained. Accordingly, a water electrolyzer having a stacked configuration contains at least two anode-containing half cells and/or at least two cathode-containing half cells.

Different types of water electrolyzer are known.

In a PEM water electrolyzer, a solid polymer electrolyte is used which is responsible for proton transport from the anode to the cathode while electrically insulating the electrodes from each other, and for separating the product gases.

Due to its complexity, the oxygen evolution reaction has slow kinetics, which is why a significant overpotential is needed at the anode side for producing oxygen at reasonable rates. Typically, PEM water electrolyzers are operated at a voltage of about 1.5 to 2 V. As the pH is very acidic (PEM: pH of less than 2) and a high overpotential has to be applied, the materials which are present in the anode side of a PEM water electrolyzer need to be very corrosion resistant.

Typically, the anode of a water electrolyzer comprises a catalyst for the oxygen evolution reaction (an OER electrocatalyst). Appropriate OER electrocatalysts are known to the skilled person and have been described e. g. by M. Carmo et al., “A comprehensive review on PEM water electrolysis”, International Journal of Hydrogen Energy, Vol. 38, 2013, pp. 4901-4934; and H. Dau et al., “The Mechanism of Water Oxidation: From Electrolysis via Homogeneous to Biological Catalysis”, ChemCatChem, 2010, 2, pp. 724-761.

It is known that iridium or ruthenium oxides are efficient catalysts for the oxygen evolution reaction (EP 2 608 297A 1 , Reier et al. Electrocatalytic Oxygen Evolution Reaction in Acidic Environments—Reaction Mechanisms and Catalysts. Adv. Energy Mater. 2017, 7, 1601275.).

However, iridium is poor in resources and expensive and ruthenium oxide has a minor stability neither singularly nor in form of an Pt—Ru-alloy. The limited resources of iridium will be a major obstacle for the roll out of PEM electrolysis technology. To expand the use of the electrolyzer, an anode made of a less expensive and abundant material is required.

As an alternative to iridium catalysts, some studies were made with platinum metal oxide using +1/+2/+3 ions like Li, Na, Mg, Ca, Zn, Cd, Co, Ni, Mn, Cu, Ag, Bi, In and Ce, wherein +1/+2 ions fit perfectly in the bronze structure.

EP 3 581 682 A1 discloses an anode for electrolysis, comprising a homogenous platinum bronze MₓPt₃O₄ containing metallic element M, wherein the metallic element M is selected from the group of Mn, Co, Cu, Ag, Bi, and Ce. These anodes are inexpensive and excellent in duration and therefore a good alternative for Ir-anodes. However, the activity is still below those of Ir-anodes.

R. D. Shannon et al., Inorg. Chem., 21, 3372 (1982 ) discloses a method of synthesizing MₓPt₃O₄ (M=Li, Na, Mg, Ca, Zn, Cd, Co, and Ni).

WO 2018/110423 A1 describes the synthesis of MₓPt₃O₄ by mixing platinum oxide (PtO₂) and the metal nitrate in a molar ratio of 3:1. As metal nitrate Co, Ce, Ca, Li, Na, Bi, Ag, Cu, Mn and In were used.

Yim et al., International Journal of Hydrogen Energy 30 (2005 ) 1345, describes a preparation method for mixed PtRuOₓ materials by physically mixing Pt and RuOₓ to obtain an electro-cata-lyst with the appropriate composition. An inorganic Ru precursor was dissolved in deionized water, and the aqueous solution was then dried at 110° C. for 12 h and subsequently calcined in air at 400° C. for 5 h to form the oxidic phase. However, this material performed only poorly as a catalyst for the oxygen evolution reaction. Kamitaka et al. Catalysts 2018, 8, 258, discloses Co—Pt bonzes for electrocatalysis in acidic media.

Cherevko et al. in “Oxygen and hydrogen evolution reactions on Ru, RuO₂, Ir, and IrO₂ thin film electrodes in acidic and alkaline electrolytes: A comparative study on activity and stability” com-pares the activity and stability of metallic and oxidic Ir and Ru materials for the acidic oxygen evolution reaction (Catalysis Today 262 (2016 ) 170-180). Cherevkov et al. concludes that RuO₂ is on par with the conventional Ir and IrO2 catalyst in terms of activity for the oxygen evolution reaction. In terms of durability Ru containing catalysts are lagging the Ir counterparts. Cherevkov et al. also found that metals have a 2-3 orders of magnitude higher dissolution rate compared to their respective oxides. A high dissolution rate implies that the catalyst is not stable under reaction conditions.

Yi et al. discloses in “Effect of Pt introduced on Ru-based electrocatalyst for oxygen evolution activity and stability”(Electrochemistry Communications 104 (2019 ) 106469) a catalyst of a composition Ru_{0.9}Pt_{0.1}O₂ which is deposited onto a carbon support. This phase was found to have some exceptional high OER activity and remarkable stability. This observation was explained twofold. Firstly, Pt dissolution from the catalyst surface generates a Pt-poor surface and forms an amorphous hydrous surface layer with unsaturated, but very active Ru sites. Secondly, the core of the catalysts remains unchanged consisting of the initial Ru_{0.9}Pt_{0.1}O₂, which is catalytically inactive, but provides the necessary stability to the amorphous hydrous and Pt-poor surface layer. Even though this catalyst shows some remarkable activity, its activity originates from an initial loss of costly Pt from the catalyst surface, which is economically unattractive. The precious metal loss is even aggregated by the applied preparation route. Yi et al. synthesizes the corresponding Ru_{0.9}Pt_{0.1} alloys and converts this material into a binary oxide using a high temperature calcination process. However, the conversion is not quantitative as the XRD analysis reveals and the presence of metal Ru components can lead to additional precious metal losses due to the intrinsically higher dissolution rates of metal. Moreover, relying on dissolution processes to achieve the desired activity makes long-term stability in commercially relevant electrolyzer systems unlikely.

A. S. Arico et al., “Electrochemical analysis of high temperature methanol electro-oxidation at Pt-decorated Ru catalysts”, Journal of Electroanalytical Chemistry 576 (2005 ), pages 161 to 169, relates to an investigation of methanol electro-oxidation at Pt-decorated unsupported Ru catalysts having a Pt loading of 0.1 mg/cm² in situ in direct methanol fuel cells at high temperatures. Qing Yao et al., “A trace of Pt can significantly boost RuO₂ for acidic water splitting”, Chinese Journal of Catalysis 43 (2022), pages 1493 to 501, discloses activation and stabilization of an RuO₂-based electrocatalyst for acidic water splitting by a trace of Pt. Experimental and theoretical analyses reveal that the atomically dispersed Pt incorporated into a RuO₂ lattice is conducive to increase the concentration of O vacancies, which effectively enhances the interaction with a reaction intermediate and thus lowers the energy barrier for the formation of OOH*.

The object of the present invention is to provide a composition which is neither based on Ir nor on a binary Ru Pt oxide phase that is inherently inactive. In addition, the composition should not rely on surface dissolution of Pt to get the needed gain activity. The object of the present invention is to identify a stabilization effect for the highly active RuO₂ structure without changing the bulk morphology and composition of this bulk material.

The inventive catalyst composition comprises ruthenium oxide, RuO₂, particles containing a RuO₂ lattice structure, wherein the RuO₂ particles have at least one transition metal (M) oxide, wherein M=Pt, Rh, Pd, Ag and/or Au, deposited on the particle surface, and wherein this transition metal (M) oxide is present in the RuO₂ phase by less than 1 wt.-% calculated as the element M, and relating to the total mass of the catalyst composition.

Contrary to other platinum ruthenium oxide catalysts, the Ru oxide phases themselves do not contain transition metal (M) oxide, preferably platinum, in an appreciable amount. Preferably, the transition metal (M) oxide is present in the RuO₂ oxides by less than 0.75 wt.-%, more preferably by less than 0.5 wt.-% calculated as the element M, and relating to the total mass of the catalyst composition. Thus, transition metal (M) oxides might be present in the RuO₂ oxides by 0 to less than 1 wt.-%, preferably by 0 to less than 0.75, more preferably by 0 to 0.5 wt.-% calculated as the element M, and relating to the total mass of the catalyst composition.

Contrary to other platinum ruthenium oxide catalysts, the catalyst composition comprises elementary transition metal (M), preferably platinum, of less than 5 wt.-%, preferably of less than 2 wt.-%, more preferably of less than 1 wt.-%, more preferably of less than 0.5 wt.-% relating to the total mass of the catalyst. Thus, elementary transition metal (M), preferably platinum, might be present in the RuO₂ oxides by 0 to less than 5 wt.-%, preferably by 0 to less than 2 wt.-%, more preferably by 0 to 1 wt.-%, more preferably by 0 to 0.5 wt.-% relating to the total mass of the catalyst composition.

The transition metal (M) oxide is preferably platinum, rhodium, palladium, silver and/or gold, more preferably platinum, palladium and/or rhodium, even more preferably platinum.

The elementary transition metal (M) is preferably platinum, rhodium, palladium, silver and/or gold, more preferably platinum, palladium and/or rhodium, even more preferably platinum.

The average layer thickness of the transition metal (M) oxide coating, preferably platinum coating, is in the range of 1 nm to 5 nm, preferably 1 nm to 3 nm. In addition, MOₓ is found finely distributed at the grain boundaries/surface of the Ru oxide particles. The average layer thickness preferably relates to a median value of the layer thickness. Determination of the thickness of the coating is preferably carried out using transmission electron microscopy (TEM) as TEM provides a means to directly measure the oxide thickness in a quantitative way. TEM is preferably carried out using a probe-corrected Themis Z 3.1 machine (Thermo-Fisher, Waltham, USA) under different acquisition modes including High-Angle Annular Dark-Field (HAADF) Scanning Transmission Electron Microscopy (STEM), integrated Differential Phase Contrast (iDPC)—STEM, Bright-Field TEM and electron diffraction.

Preferably, the crystallite size of the RuO₂ phase is in the range of 2 nm and 60 nm, more preferably in the range of 10 nm and 50 nm, even more preferably the range of 20 nm and 40 nm measured by XRD.

The transition metal oxide crystal structure cannot be detected by XRD. If a Pt oxide crystal structure should have formed in traces, then the proportion of this platinum oxide phase is less than 0.5 wt.-%; preferably below 0.25 wt.-%, more preferably below 0.1wt.-% relating total mass of the catalyst composition. Preferably, the transition metal (M) oxide, preferably the Pt oxide phase, does not lead to diffraction lines that can be assigned to it.

Preferably, all particles of the RuO₂ phase have a particle size of below 200 nm, preferably below 150, more preferably below 100, measured by TEM particle size analysis.

The particle size of the RuO₂ phase is preferably on average 5 to 150 nm, more preferably 10 to 80 nm, as characterized by TEM measurements. The shape of the particle is preferably spherical.

The deposition methods of transition metal (M) oxide, preferably of Pt oxide onto RuO₂ can be carried out using any preparation technique known to the expert. Suitable preparation methods can be, for example, incipient wetness impregnation, atomic layer deposition or chemical vapor deposition.

Another deposition process includes the steps of (a) mixing a predetermined amount of Pt oxide with a Ru precursor, (b) subjecting the raw material mixture to solid-phase reaction and (c) removing by-products from the resultant reactant. For this deposition process it is preferable to keep the sodium content equal or lower than 500 ppm.

The present invention further provides a catalyst composition comprising ruthenium oxide, RuO₂, particles containing a RuO₂ lattice structure, wherein the RuO₂ particles that have a transition metal (M) oxide deposited on the particle surface thereof, wherein M=Pt, Rh, Pd, Ag and/or Au,
wherein the transition metal (M) oxide is present in the RuO₂ phase by less than 1 wt.-% calculated as the element M, and relating to the total mass of the catalyst composition,
wherein the catalyst composition comprises the elementary transition metal (M) of less than 1 wt.-%, relating to the total mass of the catalyst.

The present invention also provides a process for obtaining a catalyst composition, wherein the composition comprises ruthenium oxide, RuO₂, particles containing a RuO₂ lattice structure, wherein the RuO₂ particles that have a transition metal (M) oxide deposited on the particle surface thereof, wherein M=Pt, Rh, Pd, Ag and/or Au,
wherein the transition metal (M) oxide is present in the RuO₂ phase by less than 1 wt.-% calculated as the element M, and relating to the total mass of the catalyst composition, the process comprising the steps of:
(a) mixing a predetermined amount of Pt oxide with a Ru precursor,
(b) subjecting the raw material mixture to solid-phase reaction, and
(c) removing by-products from the resultant reactant.

The present invention moreover provides a catalyst composition obtainable by or obtained by the aforementioned process.

Preferably, the catalyst composition comprises the elementary transition metal (M) of less than 1 wt.-%, preferably by 0 to less than 1 wt.-%, more preferably by 0 to 0.5 wt.-% relating to the total mass of the catalyst composition.

The present invention demonstrates that a material based on platinum oxide decorated ruthenium oxide shows a surprisingly high catalytic activity towards oxygen evolution reaction and is very stable under highly corrosive conditions. Ruthenium is 20 time more available than iridium. This will also solve the iridium supply issue and allow large scale PEM electrolysis installations.

### Characterization of Catalyst

The term “transition metal (M) oxide, preferably platinum oxide, decorated ruthenium oxide” means that the catalyst comprises ruthenium oxides particles that have transition metal (M) oxide, preferably platinum oxide, deposited on the particle surface.

Preferably, the transition metal (M) oxide covers at least 50% of the particle surface of the ruthenium oxides particles, more preferably at least 60%, more preferably at least 70%, more preferably at least 80%, more preferably at least 90%, and more preferably 100%, e.g. fully covers the particle surface of the ruthenium oxides particles. Analysis of the particle surface is preferably carried out using transmission electron microscopy (TEM). TEM is preferably carried out using a probe-corrected Themis Z 3.1 machine (Thermo-Fisher, Waltham, USA) under different acquisition modes including High-Angle Annular Dark-Field (HAADF) Scanning Transmission Electron Microscopy (STEM), integrated Differential Phase Contrast (iDPC)—STEM, Bright-Field TEM and electron diffraction.

Preferably, the total amount of transition metal (M) oxide, preferably platinum in the catalyst composition is within the range of from 1 to 20 wt.-%, more preferably from 5 to 15 wt.-%, more preferably from 8 to 12 wt.-% relating to the total mass of the catalyst. Preferably, the remaining amount up to 100 wt.-% is ruthenium and oxygen. Preferably, the total amount of ruthenium in the catalyst composition is within the range of from 55 to 75 wt.-%, more preferably from 60 to 70 wt.-%, more preferably from 63 to 67 wt.-% relating to the total mass of the catalyst.

The catalyst composition of the present invention has a BET surface area of from 5 to 200m²/g, preferably 20 to 150, more preferred 30 to 100m²/g.

### Support

Bulk catalysts may have a limited surface area for electrochemical activity. For increasing the catalytically active surface area, the catalyst composition might also be supported on a suitable carrier material. The carrier material is preferably an inorganic oxide, carbide or nitride material for example Antimony doped tin oxide (ATO), Titanium suboxides (TiO, Ti₂O₃, Ti₃O₅, and Ti₄O₇), TIC, ZrC, HfC, TaC, TIN, ZrN, HfN, TaN, Boron carbide, boron-oxy-carbide or boron carbides containing further elements such as boron silicon oxycarbide, more preferably TiO₂, doped or undoped SnO₂.

The present catalyst composition could also be used as a carrier material itself and be coated with additional catalytic material, e.g. with iridium.

The crystallite size may be determined by X-ray analysis. X-ray diffraction (XRD) measurement may be used for the determination of the crystallite size (diameter) and crystal orientation. Preferably, the crystallite size may be determined by diffractograms of powders. Preferably, data can be collected on a Bruker AXS D8 Advance diffractometer using a copper anode running at 40 kv and 40 mA, and running the scan from 2° to 80° (2θ) using a step size of 0.02 ° (2θ). Data may be analyzed using TOPAS 6. Crystallite size can be reported using the integral breadth method (LVol-IB) as reported by TOPAS.

The chemical composition may be analyzed via atom emission spectrometry or using energy-dispersive X-ray spectroscopy (EDXS). Preferably, the chemical composition may be analyzed with the integrated SuperX G2 Energy-Dispersive X-Ray Spectroscopy (EDXS) detectors (Thermo-Fisher, Waltham, USA). EDXS may preferably be employed for analysis of the grain boundaries/surface of the Ru particles.

Transmission electron microscopy (TEM) may be used for analysis of particle surfaces. In particular, TEM images may be employed for analysis of the particle surface of the Ru particles. TEM is preferably carried out using a probe-corrected Themis Z 3.1 machine (Thermo-Fisher, Waltham, USA) under different acquisition modes including High-Angle Annular Dark-Field (HAADF) Scanning Transmission Electron Microscopy (STEM), integrated Differential Phase Contrast (iDPC)—STEM, Bright-Field TEM and electron diffraction.

Determination of the thickness of the coating may also be carried out using TEM as TEM provides a means to directly measure the oxide thickness in a quantitative way.

Furthermore, particle size may be determined by TEM particle size analysis. Preferably, particle size analysis may be carried out using a FIJI software tool (Schindelin, J., Arganda-Carreras, I., Frise, E., Kaynig, V., Longair, M., Pietzsch, T., Cardona, A. (2012). Fiji: an open-source platform for biological-image analysis. Nature Methods, 9 (7), 676-682. doi: 10.1038/nmeth.2019).

Diffraction patterns may be evaluated using Prodas Software (Proscope, Gangelt, Germany, version: 1.4).

### Advantages

In contrast to prior art the described invention demonstrates a platinum oxide decorated ruthenium oxide catalytic material with surprisingly high activity and stability (far greater than the individual binary oxides) for the electrochemical oxygen evolution reaction under acidic conditions. The present invention solves the problem of limited Ir supply by providing an alternative based on oxides of Ru and Pt, which are elements with a significantly higher availability. In contrast to other reported Ru containing materials a higher stability is achieved. The stability is achieved by depositing platinum oxide on the surface of RuO₂ particles and not by removing platinum from the surface of the Ru containing particles.

The present invention is further illustrated by the following set of embodiments and combinations of embodiments resulting from the dependencies and back-references as indicated. In particular, it is noted that in each instance where a range of embodiments is mentioned, for example in the context of a term such as “The catalyst composition of any one of embodiments 1 to 4”, every embodiment in this range is meant to be explicitly disclosed for the skilled person, i.e. the wording of this term is to be understood by the skilled person as being synonymous to “The catalyst composition of any one of embodiments 1, 2, 3 and 4”. Further, it is explicitly noted that the following set of embodiments represents a suitably structured part of the general description directed to preferred aspects of the present invention, and, thus, suitably supports, but does not represent the claims of the present invention.

### Embodiment 1

Catalyst composition comprising ruthenium oxide, RuO₂, particles containing a RuO₂ lattice structure, wherein the RuO₂ particles have at least one transition metal (M) oxide, wherein M=Pt, Rh, Pd, Ag and/or Au, deposited on the particle surface, and wherein this transition metal (M) oxide is present in the RuO₂ phase by less than 1 wt.-% calculated as the element M, and relating to the total mass of the catalyst composition.

### Embodiment 2

A catalyst composition according to embodiment 1, wherein the proportion of a lattice structure of the transition metal (M) oxide is less than 0.5 wt.-% relating total mass of the catalyst composition.

### Embodiment 3

A catalyst composition according to embodiment 1 or 2, wherein the transition metal (M) oxides is present in the RuO₂ phase present in the RuO₂ oxides by less than 0.75 wt.-%, preferably by less than 0.5 wt.-% calculated as the element M, and relating to the total mass of the catalyst composition; or wherein the transition metal (M) oxides is present in the RuO₂ phase present in the RuO₂ oxides by 0 to less than 1 wt.-%, preferably by 0 to less than 0.75, more preferably by 0 to 0.5 wt.-% calculated as the element M, and relating to the total mass of the catalyst composition.

### Embodiment 4

A catalyst composition according to at least one of embodiments 1 to 3, wherein the catalyst composition comprises elementary transition metal (M), preferably platinum, of less than 5 wt.-%, preferably of less than 2 wt.-%, more preferably of less than 1 wt.-%, more preferably of less than 0.5 wt.-%, relating to the total mass of the catalyst; or wherein the catalyst composition comprises elementary transition metal (M) by 0 to less than 5 wt.-%, preferably by 0 to less than 2 wt.-%, more preferably by 0 to 1 wt.-%, more preferably by 0 to less than 1 wt.-%, more preferably by 0 to 0.5 wt.-%, more preferably by 0 to less than 0.5 wt.-%, relating to the total mass of the catalyst composition.

### Embodiment 5

A catalyst composition according to at least one of embodiments 1 to 4, wherein the transition metal (M) oxide is platinum, rhodium, palladium, silver and/or gold, preferably platinum, palladium and/or rhodium, more preferably platinum; and/or
wherein the elementary transition metal (M) is platinum, rhodium, palladium, silver and/or gold, preferably platinum, palladium and/or rhodium, more preferably platinum.

### Embodiment 6

A catalyst composition according to at least one of embodiments 1 to 5, wherein the average layer thickness of the transition metal (M) oxide coating, preferably platinum coating, is in the range of 1 nm to 5 nm, preferably 1 nm to 3 nm.

### Embodiment 7

A catalyst composition according to at least one of embodiments 1 to 6, wherein the crystallite size of the RuO₂ phase is in the range of 2 nm and 60 nm, preferably in the range of 10 nm and 50 nm, more preferably the range of 20 nm and 40 nm measured by XRD.

### Embodiment 8

A catalyst composition according to at least one of embodiments 1 to 7, wherein, if a Pt oxide crystal structure should have formed in traces, then the proportion of this platinum oxide phase is less than 0.5 wt.-%; preferably below 0.25 wt.-%, more preferably below 0.1wt.-%, relating total mass of the catalyst composition.

### Embodiment 9

A catalyst composition according to at least one of embodiments 1 to 8, wherein all particles of the RuO₂ phase have a particle size of below 200 nm, preferably below 150, more preferably below 100, measured by TEM particle size analysis.

### Embodiment 10

A catalyst composition according to at least one of embodiments 1 to 9, wherein the particle size of the RuO₂ phase is on average 5 to 150 nm, preferably 10 to 80 nm,

### Embodiment 11

A catalyst composition according to at least one of embodiments 1 to 10, wherein the total amount of transition metal (M) oxide, preferably platinum, in the catalyst composition, is within the range of from 1 to 20 wt.-%, preferably from 5 to 15 wt.-%, preferably from 8 to 12 wt.-%, relating to the total mass of the catalyst; and/or wherein the remaining amount up to 100 wt.-% is ruthenium and oxygen; and/or wherein the total amount of ruthenium in the catalyst composition is within the range of from 55 to 75 wt.-%, preferably from 60 to 70 wt.-%, more preferably from 63 to 67 wt.-%, relating to the total mass of the catalyst.

### Embodiment 12

A catalyst composition according to at least one of embodiments 1 to 11, wherein the catalyst composition has a BET surface area of from 5 to 200 m²/g, preferably 20 to 150, more preferred 30 to 100 m²/g.

### Embodiment 13

A catalyst composition according to at least one of embodiments 1 to 12, wherein the catalyst composition is supported on a carrier material, wherein the carrier material is preferably an inorganic oxide, carbide or nitride material.

### Embodiment 14

A catalyst composition according to at least one of embodiments 1 to 12, wherein the catalyst composition is used as a carrier material itself, preferably wherein the catalyst composition is coated with additional catalytic material, which preferably is iridium.

### Embodiment 15

A catalyst composition according to at least one of embodiments 1 to 14, wherein the catalyst composition comprises elementary transition metal (M) of less than 2 wt.-% relating to the total mass of the catalyst.

### Embodiment 16

A catalyst composition according to at least one of embodiments 1 to 15, wherein the average layer thickness of the transition metal (M) oxide coating is in the range of 1 nm to 5 nm.

### Embodiment 17

A catalyst composition according to at least one of embodiments 1 to 16, wherein the crystallite size of the RuO₂ phase is in the range of 2 nm and 60 nm, measured by XRD.

### Embodiment 18

A catalyst composition according to at least one of embodiments 1 to 17, wherein the particle size of the RuO₂ phase is on average 5 to 150 nm, as characterized by TEM measurements.

### Embodiment 19

A catalyst composition according to at least one of embodiments 1 to 18, wherein catalyst com-position contains 1 to 20 wt.-% transition metal (M) oxide, 55 to 75 wt.-% ruthenium, and the remaining amount up to 100 wt.-% oxygen relating to the total mass of the catalyst.

### Embodiment 20

A catalyst composition according to at least one of embodiments 1 to 19, wherein the transition metal (M) oxide is platinum, rhodium and/or palladium, preferably wherein the transition metal (M) oxide is platinum.

### Embodiment 21

Catalyst composition comprising ruthenium oxide, RuO₂, particles containing a RuO₂ lattice structure, wherein the RuO₂ particles that have a transition metal (M) oxide deposited on the particle surface thereof, wherein M=Pt, Rh, Pd, Ag and/or Au, wherein the transition metal (M) oxide is present in the RuO₂ phase by less than 1 wt.-% calculated as the element M, and relating to the total mass of the catalyst composition, wherein the catalyst composition comprises the elementary transition metal (M) of less than 1 wt.-%, relating to the total mass of the catalyst.

### Embodiment 22

Process for obtaining a catalyst composition, wherein the composition comprises ruthenium oxide, RuO₂, particles containing a RuO₂ lattice structure, wherein the RuO₂ particles that have a transition metal (M) oxide deposited on the particle surface thereof, wherein M=Pt, Rh, Pd, Ag and/or Au,
wherein the transition metal (M) oxide is present in the RuO₂ phase by less than 1 wt.-% calculated as the element M, and relating to the total mass of the catalyst composition, the process comprising the steps of:
(a) mixing a predetermined amount of Pt oxide with a Ru precursor,
(b) subjecting the raw material mixture to solid-phase reaction and
(c) removing by-products from the resultant reactant.

### Embodiment 23

Catalyst composition obtainable by or obtained by the process of embodiment 22.

### Embodiment 24

A catalyst composition according to embodiment 23, wherein the catalyst composition comprises the elementary transition metal (M) of less than 1 wt.-%, relating to the total mass of the catalyst.

### Embodiment 25

An electrochemical device, comprising the catalyst composition according to any one of the aforementioned embodiments.

### Embodiment 26

Use of a catalyst composition according to any one of the aforementioned embodiments as a catalyst for an oxygen evolution reaction.

### EXAMPLES

### Experimental Procedures

### 1. X-Ray Diffractograms of Powders

The samples were homogenized in a mortar and flattened into a sample holder and data collected on a Bruker AXS D8 Advance diffractometer using a copper anode running at 40 kv and 40 mA. The scan was run from 2° to 80° (2θ) using a step size of 0.02° (2θ). Data was analyzed using TOPAS 6⁽¹⁾. Crystallite size was reported using the integral breadth method (LVol-IB) as reported by TOPAS.

### LITERATURE

(1) TOPAS 6 User Manual, 2017, Bruker AXS GmbH. Karlsruhe, Germany

### 2. TEM Images and EDS Mapping

Powder samples were dispersed in ethanol and applied on an ultra-thin carbon-coated grid by the drop-on-grid-method. The samples were imaged by Transmission Electron Microscopy (TEM) using a probe-corrected Themis Z 3.1 machine (Thermo-Fisher, Waltham, USA) under different acquisition modes including High-Angle Annular Dark-Field (HAADF) Scanning Transmission Electron Microscopy (STEM), integrated Differential Phase Contrast (iDPC)—STEM, Bright-Field TEM and electron diffraction. The chemical composition was analyzed with the integrated SuperX G2 Energy-Dispersive X-Ray Spectroscopy (EDXS) detectors (Thermo-Fisher, Waltham, USA). Data was analyzed using the Velox 2.1x software (Thermo-Fisher, Waltham, USA). Particle size analysis was performed using the FIJI software tool (Schindelin, J., Arganda-Carreras, I., Frise, E., Kaynig, V., Longair, M., Pietzsch, T., Cardona, A. (2012). Fiji: an open-source platform for biological-image analysis. Nature Methods, 9 (7), 676-682. doi: 10.1038/nmeth.2019). Diffraction patterns were evaluated using Prodas software (Proscope, Gangelt, Germany, version: 1.4)

### 3. Electrochemical Measurements

Experiments were conducted in 0.5 M H₂SO₄ electrolyte at room temperature and under an atmosphere of argon. The catalyst was dispersed into H₂O/IPA 10/1 at 1 wt.-% to obtain an ink via ultrasonication, which was drop casted onto a gold electrode. All catalysts were deposited as to achieve the same total mass loading on the electrode as a thin film. The electrode was immersed into the electrolyte and the activity measured via linear sweep voltammetry in the potential range of 1.2 to 1.7 V versus the reversible hydrogen electrode (RHE).

### PREPARATION OF THE EXAMPLES

### Inventive Sample

A Platinum oxide decorated ruthenium oxide was prepared following the method. The mixing was carried out by dripping Ru(NO)NO₃ solution from BASF Italia (Lot. No: 9002401825) with a Ru content of 18.8 wt.-% onto the PtO 2 precursor by completely covering/wetting of the solid precursor. The atomic platinum to ruthenium ratio of this precursor was 3:1. PtO₂ with a Na content of 500ppm from Sigma Aldrich (Art. No. 40402) was used.

The PtO₂ impregnated with the Ru-containing solution was then ground to a fine powder. The powder was then dried and thermally treated using the following protocol.
1. Drying at 80° C. for 12 h
2. Heating up to 650° C. at 5K/min
3. Maintaining 650° C. for 6 h
4. Cool Down (10k/min)

After the thermal treatment, the sample was treated with aqua regia at 80° C. for 30 min. The aqua regia treated sample was then again dried at 80° C. for 12 h. The composition of the resulting material was checked via atom emission spectrometry. One sample was prepared following this procedure, BRZ-12. The sample contained 8.9 wt.-% of platinum.

### Comparative Example

For the comparative examples PtO2 and RuO₂ containing samples were prepared similar to the inventive sample, but platinum and ruthenium were dried and calcined separately. PtO₂ with a Na content of 1.6 wt.-% from Sigma Aldrich from Sigma Aldrich (Art. No. 206032) was used as the Pt containing material. Ru(NO)NO₃ solution from BASF Italia (Lot. No: 9002401825) with a Ru content of 18.8 wt.-% (as used in the inventive example) was used as the inorganic Ru precursor. This aqueous Ru solution was dried and thermally treated separately in the absence of the other metal precursor. The following protocol was:
1. Drying at 80° C. (drying was carried out in a vacuum drying oven and drying was ex-tended until the solution has turned into a dried powder)
2. Heating up to 650° C. at 5K/min
3. Maintaining 650° C. for 6 h
4. Cool down (10k/min)

The individually thermally treated samples were then physically mixed and ground to a fine powder. A portion of this material was subjected to the same aqua regia treatment as described in the INVENTIVE EXAMPLE. Two samples were prepared following this procedure. The samples H2-PEM-192-2 and H2-PEM-194-2 contained 45 wt.-% and 58 wt.-% of platinum, respectively.

### Comparison of Inventive and Comparative Examples

### TEM

Fehler! Verweisquelle konnte nicht gefunden werden. FIG. 1 depicts TEM image and elemental mapping EDXS for the INVENTIVE SAMPLE. TEM images reveal that the core of the particles consists of RuO₂ and Pt can only be detected on the particle surface In addition, PtOx is found finely distributed at the grain boundaries/surface of the Ru particles.

FIG. 2 shows TEM images of the COMPARATIVE SAMPLE after AR treatment. In contrast to the INVENTIVE SAMPLE, distinct Ru and Pt rich particles are both visible in the COMPARATIVE SAMPLE (H2-PEM-192, FIG. 2). The Pt particles of COMPARATIVE SAMPLE have a pronounced cubic shape.

### XRD

FIG. 3 shows the diffraction patterns of INVENTIVE SAMPLE. The reflections of the sample only originate from the tetragonal RuO₂ lattice. The crystallite size of the RuO₂ was calculated to 25 nm. XRD measurement confirm that the material primarily consists of a RuO₂ lattice structure.

FIG. 4 shows the diffraction patterns of the COMPARATIVE SAMPLE. The reflections of the sample originate from the tetragonal RuO₂, elemental Pt and Pt₃O₄ lattices can be detected. The crystallite sizes are 70 nm, 47 nm and 39 nm, respectively.

### Electrochemical Activity of Inventive and Comparative Examples

### a) Electrochemical Cycle to Cycle Stability

A comparison of the INVENTIVE SAMPLE (BRZ-12) to RuO₂ (Alfa Aesar), utilizing the method-ology described in a, (see FIG. 5) shows that while conventional RuO₂ has a very high initial activity, when cycling the material between 1.2 and 1.7 V vs RHE for numerous cycles, the activity is lost quickly and completely vanishes after 30 cycles (see FIG. 5a), while activity of the INVENTIVE SAMPLE is completely retained (see FIG. 5b). Experiments were conducted in 0.5 M H₂SO₄ electrolyte at room temperature and under an atmosphere of argon. The catalyst was dispersed into H₂O/IPA 10/1 at 1 wt.-% to obtain an ink via ultrasonication, which was drop casted onto a gold electrode. All catalysts were deposited as to achieve the same total mass loading on the electrode as a thin film. The electrode was immersed into the electrolyte and the activity measured via linear sweep voltammetry in the potential range of 1.2 to 1.7V versus the reversible hydrogen electrode (RHE).

### b) Electrochemical Activity

A comparison of the INVENTIVE SAMPLE (BRZ-12) with a non-inventive Comparative Example (H2-PEM-192-1) (see FIG. 6), shows that a significantly higher activity is obtained by the inventive Example. Experiments were conducted in 0.5 M H₂SO₄ electrolyte at room temperature and under an atmosphere of argon. The catalyst was dispersed into H₂O/IPA 10/1 at 1 wt.-% to obtain an ink via ultrasonication, which was drop casted onto a gold electrode. All catalysts were deposited as to achieve the same total mass loading on the electrode as a thin film. The electrode was immersed into the electrolyte and the activity measured via linear sweep voltammetry in the potential range of 1.2 to 1.7V versus the reversible hydrogen electrode (RHE).

The inventive catalyst is stable and active for the acidic oxygen evolution reaction.

### FIGURES

FIG. 1: TEM image and elemental mapping for the INVENTIVE SAMPLE

FIG. 2: TEM image and elemental mapping for the COMPARATIVE SAMPLE

FIG. 3: Diffraction patterns of the INVENTIVE SAMPLE

FIG. 4: Diffraction patterns of the COMPARATIVE SAMPLE.

FIG. 5: Electrochemical cycle to cycle stability of b) RuO₂ against the a) INVENTIVE SAMPLE

FIG. 6: Electrochemical activity of the INVENTIVE SAMPLE compared against the COMPARATIVE SAMPLE

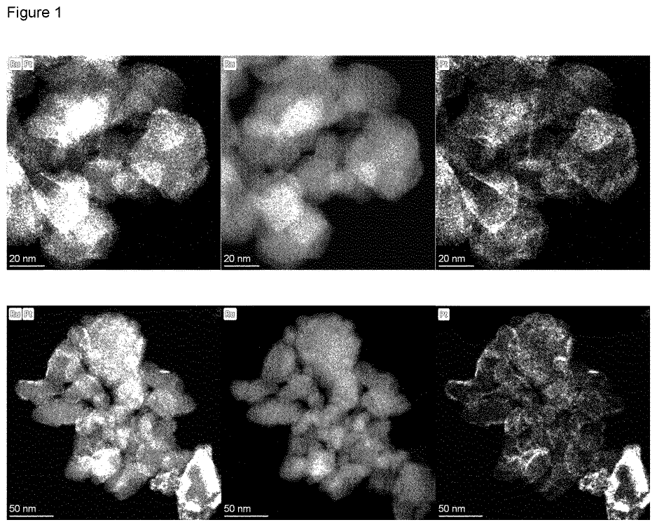

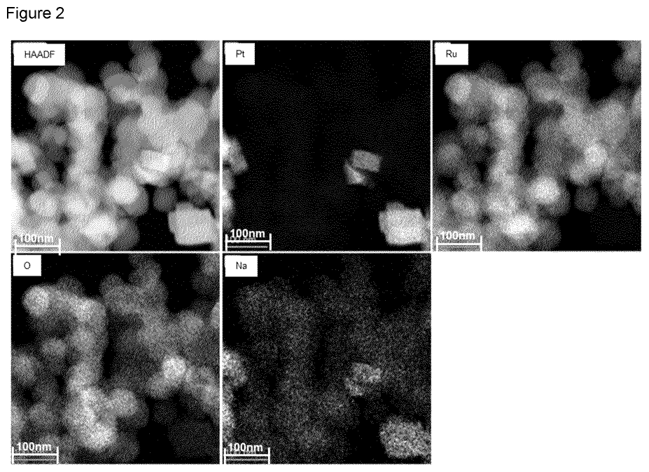

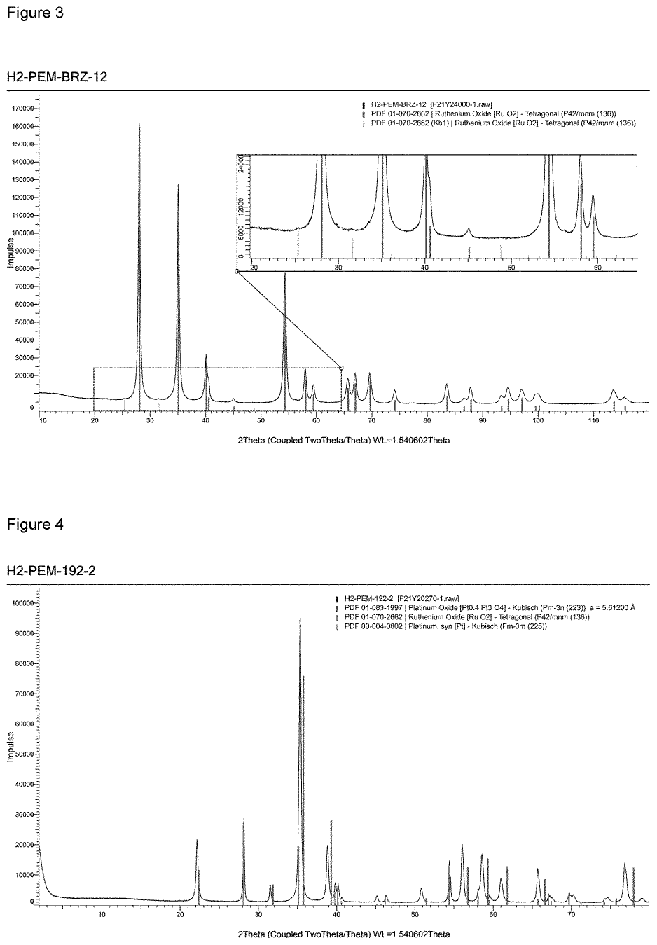

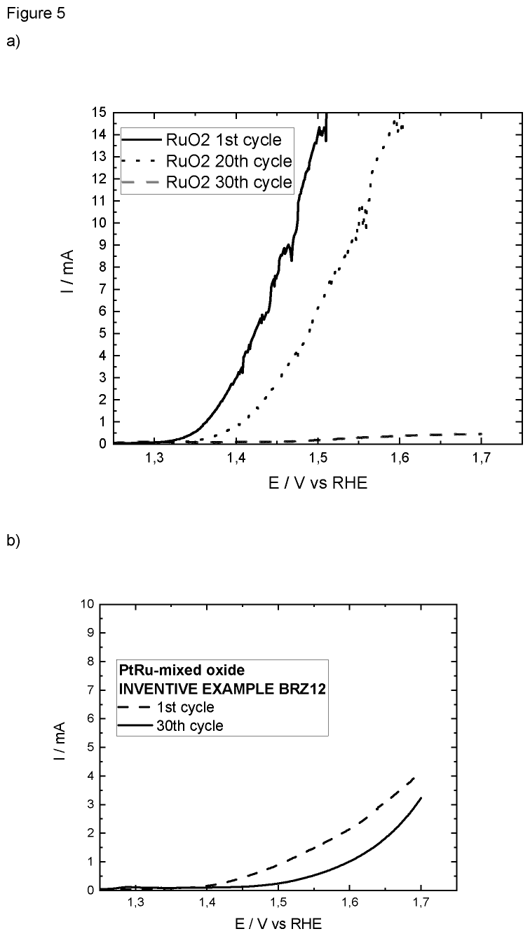

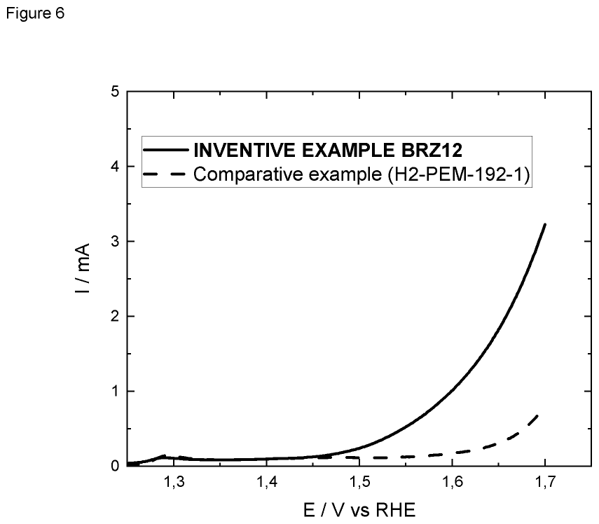

### CITED LITERATURE

M. Carmo et al., “A comprehensive review on PEM water electrolysis”, International Journal of Hydrogen Energy, Vol. 38, 2013, pp. 4901-4934
H. Dau et al., “The Mechanism of Water Oxidation: From Electrolysis via Homogeneous to Biological Catalysis”, ChemCatChem, 2010, 2, pp. 724-761
EP 2 608 297 A1
Reier et al., “Electrocatalytic Oxygen Evolution Reaction in Acidic Environments—Reaction Mechanisms and Catalysts” Adv. Energy Mater. 2017, 7, 1601275 EP 3 581 682 A1
R. D. Shannon et al., Inorg. Chem., 21, 3372 (1982 )
WO 2018/110423 A1
Yim et al., International Journal of Hydrogen Energy 30 (2005 ) 1345
Kamitaka et al. Catalysts 2018, 8, 258
Cherevko et al., “Oxygen and hydrogen evolution reactions on Ru, RuO₂, Ir, and IrO₂ thin film electrodes in acidic and alkaline electrolytes: A comparative study on activity and stability”, Catalysis Today 262 (2016 ) 170-180
Yi et al., “Effect of Pt introduced on Ru-based electrocatalyst for oxygen evolution activity and stability”, Electrochemistry Communications 104 (2019 ) 106469)
A. S. Arico et al., “Electrochemical analysis of high temperature methanol electro-oxidation at Pt-decorated Ru catalysts”, Journal of Electroanalytical Chemistry 576 (2005 ), pages 161 to 169
Qing Yao et al., “A trace of Pt can significantly boost RuO₂ for acidic water splitting”, Chinese Journal of Catalysis 43 (2022 ), pages 1493 to 501

1. A catalyst composition comprising ruthenium oxide, RuO₂, particles containing a RuO₂ lattice structure, wherein the RuO₂ particles have at least one transition metal (M) oxide, wherein M=Pt, Rh, Pd, Ag and/or Au, deposited on the particle surface, and wherein this transition metal (M) oxide is present in the RuO₂ phase by less than 1 wt.-% calculated as the element M, and relating to the total mass of the catalyst composition.

2. The catalyst composition according to claim 1, wherein the proportion of a lattice structure of the transition metal (M) oxide is less than 0.5 wt.-% relating total mass of the catalyst composition.

3. The catalyst composition according to claim 1, wherein the transition metal (M) oxides is present in the RuO₂ phase by less than 0.5 wt.-% calculated as the element M, and relating to the total mass of the catalyst composition.

4. The catalyst composition according to claim 1, wherein the catalyst composition comprises elementary transition metal (M) oxide of less than 2 wt.-% relating to the total mass of the catalyst.

5. The catalyst composition according to claim 1, wherein the average layer thickness of the transition metal (M) oxide coating is in the range of 1 nm to 5 nm.

6. The catalyst composition according to claim 1, wherein the crystallite size of the RuO₂ phase is in the range of 2 nm and 60 nm, measured by XRD.

7. The catalyst composition according to claim 1, wherein the particle size of the RuO₂ phase is on average 5 to 150 nm, as characterized by TEM measurements.

8. The catalyst composition according to claim 1, wherein catalyst composition contains 1 to 20 wt.-% transition metal (M) oxide, 55 to 75 wt.-% ruthenium, and the remaining amount up to 100 wt.-% oxygen relating to the total mass of the catalyst.

9. The catalyst composition according to claim 1, wherein the transition metal (M) oxide is platinum, rhodium and/or palladium, preferably wherein the transition metal (M) oxide is platinum.

10. A catalyst composition comprising ruthenium oxide, RuO₂, particles containing a RuO₂ lattice structure, wherein the RuO₂ particles that have a transition metal (M) oxide deposited on the particle surface thereof, wherein M=Pt, Rh, Pd, Ag and/or Au,
wherein the transition metal (M) oxide is present in the RuO₂ phase by less than 1 wt.-% calculated as the element M, and relating to the total mass of the catalyst composition, and
wherein the catalyst composition comprises the elementary transition metal (M) of less than 1 wt.-%, relating to the total mass of the catalyst.

11. A process for obtaining a catalyst composition, wherein the composition comprises ruthenium oxide, RuO₂, particles containing a RuO₂ lattice structure, wherein the RuO₂ particles that have a transition metal (M) oxide deposited on the particle surface thereof, wherein M=Pt, Rh, Pd, Ag and/or Au,
wherein the transition metal (M) oxide is present in the RuO₂ phase by less than 1 wt.-% calculated as the element M, and relating to the total mass of the catalyst composition, the process comprising the steps of:
(a) mixing a predetermined amount of Pt oxide with a Ru precursor,
(b) subjecting the raw material mixture to solid-phase reaction and
(c) removing by-products from the resultant reactant.

12. The Ecatalyst composition obtainable by or obtained by the process of claim 11.

13. The catalyst composition according to claim 12, wherein the catalyst composition comprises the elementary transition metal (M) of less than 1 wt.-%, relating to the total mass of the catalyst.

14. An electrochemical device, comprising a catalyst composition comprising ruthenium oxide, RuO₂, particles containing a RuO₂ lattice structure, wherein the RuO₂ particles have at least one transition metal (M) oxide, wherein M=Pt, Rb, Pd, Ag and/or Au, deposited on the particle surface, and wherein this transition metal (M) oxide is present in the RuO₂ phase by less than 1 wt.-% calculated as the element M, and relating to the total mass of the catalyst composition, or comprising the catalyst composition according to claim 10.

15. A use of a catalyst composition comprising ruthenium oxide, RuO₂, particles containing a RuO₂ lattice structure, wherein the RuO₂ particles have at least one transition metal (M) oxide, wherein M=Pt, Rb, Pd, Ag and/or Au, deposited on the particle surface, and wherein this transition metal (M) oxide is present in the RuO₂ phase by less than 1 wt.-% calculated as the element M, and relating to the total mass of the catalyst composition, or according to claim 10, as a catalyst for an oxygen evolution reaction.
